(19) United States
(12) Patent Application Publication
(10) Pub. No.: US 2008/0218607 A1
(43) Pub. Date: Sep. 11, 2008

(54) DISTORTION CORRECTION FOR PHOTOGRAPHING DEVICE

(75) Inventors: Takaaki SHOJI, Saitama (JP); Nobuo ARIKAWA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 12/043,428

(22) Filed: Mar. 6, 2008

(30) Foreign Application Priority Data
Mar. 8, 2007 (JP) 2007-058606

(51) Int. Cl. H04N 5/217

(52) U.S. Cl. 348/241; 348/E05.078

(57) ABSTRACT

A photographing device comprises a lens and a camera. The camera body has an imaging device and an image-processing unit that performs distortion correction on the basis of information regarding distortion quantity, as part of an image processing of an image signal obtained by the imaging device through the lens. The distortion quantity has at least one of first distortion quantity of the lens and second distortion quantity of the imaging device. The information has a coefficient of an approximation formula for the distortion correction on a two-dimensional coordinate system for the distortion correction. The two-dimensional coordinate system is set on an image obtained by the image processing of the image signal.

### BACKGROUND OF THE INVENTION

1. Field of the Invention

The present invention relates to a photographing device that performs distortion correction as part of the image processing.

2. Description of the Related Art

A distortion-correction device that performs distortion correction for correcting the distortion due to the optical characteristics of a lens is proposed.

Japanese unexamined patent publication (KOKAI) No. 2005-45513 discloses a distortion-correction device that performs distortion correction for correcting the distortion due to the optical characteristics of the lens, while accounting for the deviation between the intersection of the optical axis of the lens with the imaging surface of the imaging device and the center of the imaging surface.

However, this distortion-correction device only applies to distortion with a symmetrical distortion.

### SUMMARY OF THE INVENTION

Therefore, an object of the present invention is to provide a photographing device that accurately performs distortion correction even on distortion with an asymmetrical distribution.

According to the present invention, a photographing device comprises a lens and a camera. The camera body has an imaging device and an image-processing unit that performs distortion correction on the basis of information regarding distortion quantity, as part of an image processing of an image signal obtained by the imaging device through the lens. The distortion quantity has at least one of first distortion quantity of the lens and second distortion quantity of the imaging device. The information has a coefficient of an approximation formula for the distortion correction on a two-dimensional coordinate system for the distortion correction. The two-dimensional coordinate system is set on an image obtained by the image processing of the image signal.

### BRIEF DESCRIPTION OF THE DRAWINGS

The objects and advantages of the present invention will be better understood from the following description, with reference to the accompanying drawings in which:

FIG. 1 is a construction diagram of the photographing device in the embodiment;

FIG. 2 shows a relationship between the lens, the imaging surface of the imaging device, and the architectonics-distortion curve, when the central deviation and the surface-inclination do not exist;

FIG. 3 shows a relationship between the lens, the imaging surface of the imaging device, and the architectonics-distortion curve, when central deviation does exist;

FIG. 4 shows a relationship between the lens, the imaging surface of the imaging device, and the architectonics-distortion curve, when surface-inclination does exist;

FIG. 5 shows the image, the first lines, and the distortion curves of the first approximation formulas; and

FIG. 6 shows the image, the second lines, and the distortion curves of the second approximation formulas.

### DESCRIPTION OF THE PREFERRED EMBODIMENTS

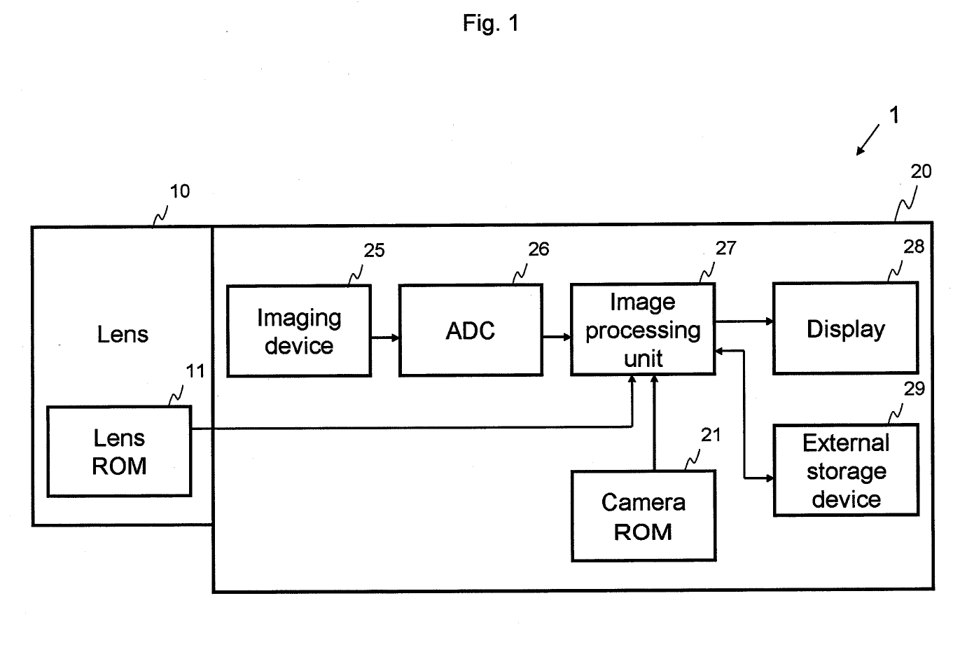

The present invention is described below with reference to the embodiment shown in the drawings. In the embodiment, the photographing device 1 is a digital camera and has a lens 10 and a body 20 (see FIG. 1).

The lens 10 has a lens ROM 11 that stores lens-distortion data DL that is the information regarding the distortion quantity of the lens 10.

The body 20 has a camera ROM 21, an imaging device 25, an ADC (Analog-Digital Converter) 26, an image-processing unit 27, a display 28, and an external storage device 29.

The camera ROM 21 stores camera-distortion data DC that is the information regarding the distortion quantity of the imaging device 25.

At the imaging device 25, photoelectric conversion of the light which forms the photographic subject image is performed, and an analog photoelectric signal is produced. At the ADC 26, A/D conversion of the analog photoelectric signal is performed.

The image data, which is the A/D-converted digital data from the ADC 26, is input to the image-processing unit 27.

The image-processing unit 27, which consists of the DSP, etc., performs image processing in order to display the image data on the display 28 or in order to store the image data into the external storage device 29.

Furthermore, the image-processing unit 27 performs distortion correction of the image data that is generated by the lens 10 and the body 20, as part of the image processing.

Specifically, during distortion correction, the image-processing unit 27 calculates the distortion quantity of each two-dimensional coordinate point on the image P obtained from the processed image data, on the basis of the lens distortion data DL and the camera distortion data DC. The distortion quantity includes the lens distortion quantity and the camera distortion quantity.

Then, the image-processing unit 27 corrects the image data on the basis of the calculated distortion quantity.

In other words, during distortion correction, the image-processing unit 27 converts the two-dimensional coordinates (X′, Y′) on the image before distortion correction, to the two-dimensional coordinates (x, y) on the image after distortion correction, on the basis of the approximation formula which considers the calculated distortion quantity (the approximation formula for distortion correction).

The lens distortion data DL is the information regarding the lens distortion quantity due to the optical characteristics of the lens 10.

The lens distortion data DL contains a coefficient of the three-dimensional formula for the lens distortion quantity.

The three-dimensional formula for the lens distortion quantity is an approximation formula for distortion correction on the basis of the distortion quantity of the lens 10, in other words, it is a coordinate transformation formula which considers the distortion quantity or the formula for the distortion quantity corresponding to the first coordinate value X′ and the second coordinate value Y′ before distortion correction.

The three-dimensional formula for the lens distortion quantity is used for calculating the approximate value of lens distortion quantity at the two-dimensional coordinates for the purpose of distortion correction.

Distortion-correction coefficients A, B, C, A′, B′, and C′, in a first relational formula (the coordinate transformation formula) between the two-dimensional coordinates (X′, Y′) in the image before distortion correction and the two-dimensional coordinates (x, y) in the image after distortion correction, are cited as the coefficients of the three-dimensional formula for the lens distortion quantity.

The first relational formula is shown by:

XX=M×(x−x_{d})+(x_{d}+x_{off});

YY=M×(y−y_{d})+(y_{d}+y_{off});

Z²={Sₓ×(XX−x_{d})}²+{S_{y}×(YY−Y_{d})}²;

X′=(XX−x_{d})×(1+A×Z²+B×Z⁴+C×Z′⁶+ . . . )×(1+A′×x²+B′×x⁴+C′×x⁶+ . . . )+x_{d}; and

Y′=(YY−y_{d})×(1+A×Z²+B×Z⁴+C×Z⁶+ . . . )×(1+A′×y²+B′×y⁴+C′×y⁶+ . . . )+y_{d}.

In the first relational formula, the two-dimensional coordinate values x and y, representing the pixel position (x, y), denote coordinates in the corrected image after distortion correction.

The two-dimensional coordinate values X′ and Y′ representing the pixel position (X′, Y′), denote coordinates in the captured image before distortion correction.

The two-dimensional coordinate values x_{d} and y_{d} denote the coordinates of the distortion center.

The two-dimensional coordinate values x_{off} and y_{off} denote the coordinates of the correction of central deviation.

The reference symbol M denotes the correcting range magnification.

The two-dimensional coordinate values sₓ and s_{y} denote the sampling ratios.

The reference symbols A, B, C, A′, B′, and C′ denote the distortion-correction coefficients.

The reference symbol Z denotes the distance from the distortion center (x_{d}, y_{d}) to the target point (x, y).

The three-dimensional formula for the lens distortion quantity, which is used for calculating the approximate value of the lens distortion quantity, is determined on the basis of a second relational formula and alignment values.

Therefore, the lens distortion quantity is calculated on the basis of the second relational formula and the alignment values.

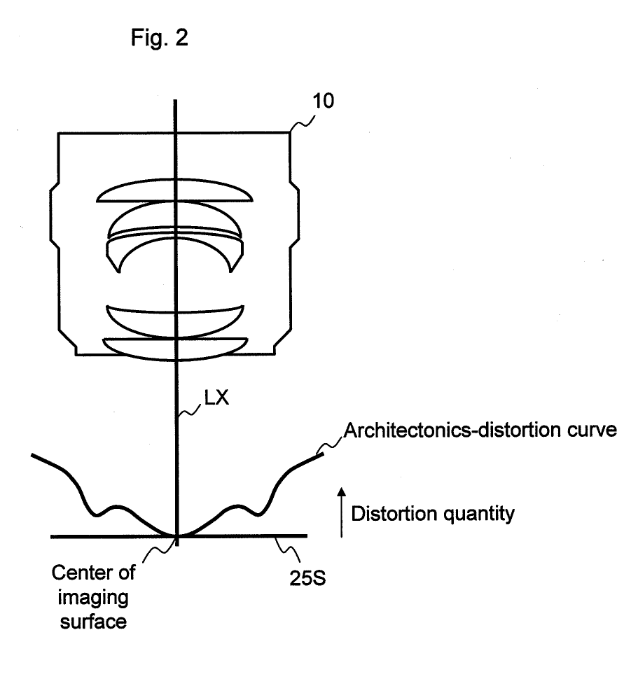

The second relational formula is the relational formula between an architectonics-distortion quantity due to the optical characteristics determined by the design of the lens 10 and the distance between the target point and an architectonics-distortion center that is the position where the architectonics-distortion quantity shows the minimum value. In other words, the second relational formula is the architectonics-distortion curve (see FIG. 2).

The alignment values include a central deviation value and a surface-inclination value that are calculated by the alignment operation during manufacturing of the lens 10. The details of the central deviation value and the surface-inclination value are described later.

When the values of the two-dimensional coordinates (X′, Y′) on the image before distortion correction are input to the three-dimensional formula for the lens distortion quantity, in other words, the first relational formula, the lens distortion quantity at the point (X′, Y′) is calculated and then the values of the two-dimensional coordinates (x, y) on the image after distortion correction with the calculated lens distortion quantity at the point (X′, Y′) are calculated.

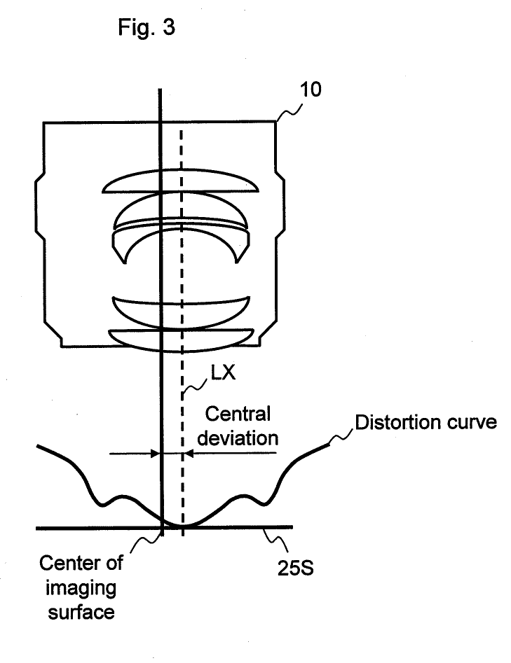

The central deviation value is the deviation between the intersection of the optical axis LX of the lens 10 with the imaging surface 25S of the imaging device 25 and the center of the imaging surface 25S (see FIG. 3).

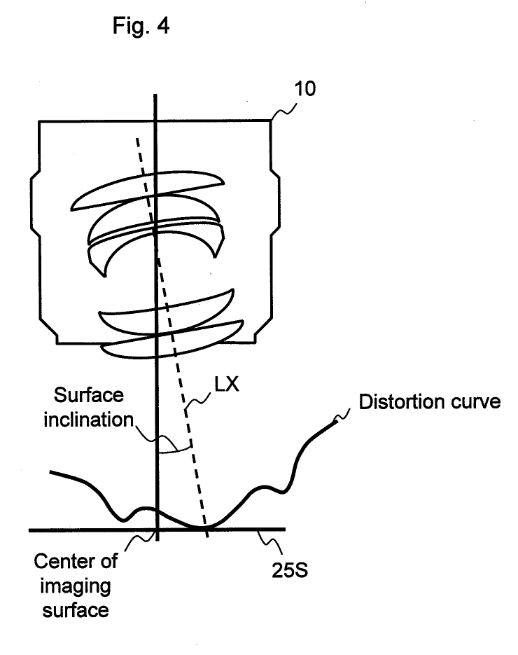

The surface-inclination value is the inclination angle of the surface perpendicular to the optical axis LX of the lens 10, in the direction of the imaging surface 25S (see FIG. 4). In other words, the surface-inclination value is the inclination angle at which the surface perpendicular to the optical axis LX crosses the imaging surface 25S.

Furthermore, when the values of the distortion-correction coefficients A, B, C, A′, B′, and C′ of the three-dimensional formula for the lens distortion quantity, are set to values accounting for the limb darkening of the lens 10, the distortion correction accounting for the limb darkening of the lens 10 can be performed.

The camera distortion data DC is the information regarding the camera distortion quantity due to various types of optical distortion such as limb darkening of the imaging device 25, etc., the characteristics of the imaging device 25, and the characteristics of micro lenses on the imaging device 25.

The camera distortion data DC has a coefficient of the three-dimensional formula for the camera distortion quantity.

The three-dimensional formula for the camera distortion quantity is an approximation formula for distortion correction on the basis of the distortion quantity of the camera (the imaging device 25).

The three-dimensional formula for the camera distortion quantity is used for calculating the approximate value of the camera distortion quantity at the two-dimensional coordinates for the purpose of distortion correction.

In the embodiment, the distortion correction considers not only the lens distortion quantity but also the camera distortion quantity. Therefore, accurate distortion correction can be performed compared to the case in which distortion correction considers only the lens distortion quantity.

Furthermore, the data regarding the various types of distortion quantity are stored as coefficients of the approximation formula for calculating the distortion quantity in the lens ROM 11, etc. Therefore, the data regarding the distortion quantity can be stored without enlarging the capacity of the ROM, as compared to the case in which the distortion quantities of the plurality of measurement points on the two-dimensional coordinate system for distortion correction are stored in the lens ROM 11 as the information regarding distortion quantity.

Furthermore, in the embodiment, the approximation formula for distortion correction handles distortion with an asymmetrical distribution. The approximation formula includes the approximation formula for calculating the distortion quantity and the approximation formula for performing the coordinate transformation.

Therefore, accurate distortion correction of distortion with point-unsymmetrical distribution can be achieved.

In the embodiment, not only the central deviation value but also the surface-inclination value are considered for calculating the lens distortion quantity. Therefore, additional accuracy in distortion correction can be gained.

Furthermore, the approximation formula for calculating the distortion quantity is not limited to the three-dimensional formula for the lens distortion quantity in the embodiment.

For example, two types of two-dimensional formulas are cited as approximation formulas.

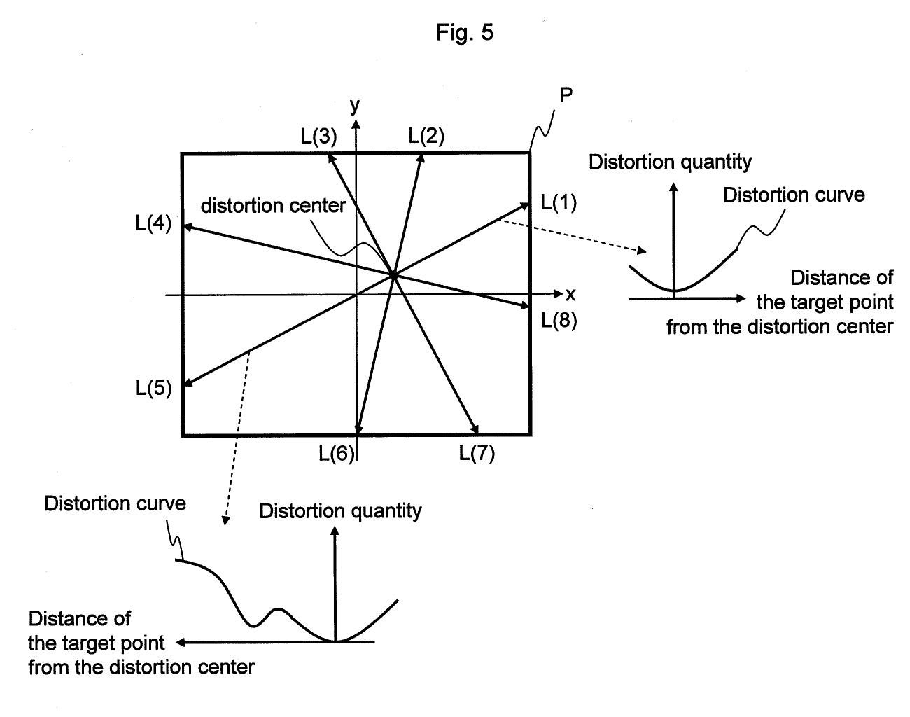

The first type of two-dimensional formula has a plurality of first approximation formulas along a plurality of first lines for specifying distortion quantity (see FIG. 5). The first lines radiate from the distortion center. The distortion center is the position where the distortion quantity shows the minimum value on the two-dimensional coordinate system for distortion correction. FIG. 5 shows the first lines consisting of seven radiating lines.

Each of the first approximation formulas gives a first relationship between the distortion quantity of the target point on each of the first lines and the position of the target point. For example, the position of the target point is given by its distance from the distortion center.

By using the first approximation formulas, the distortion quantity of the target point on or near the first lines is calculated according to the position of the target point.

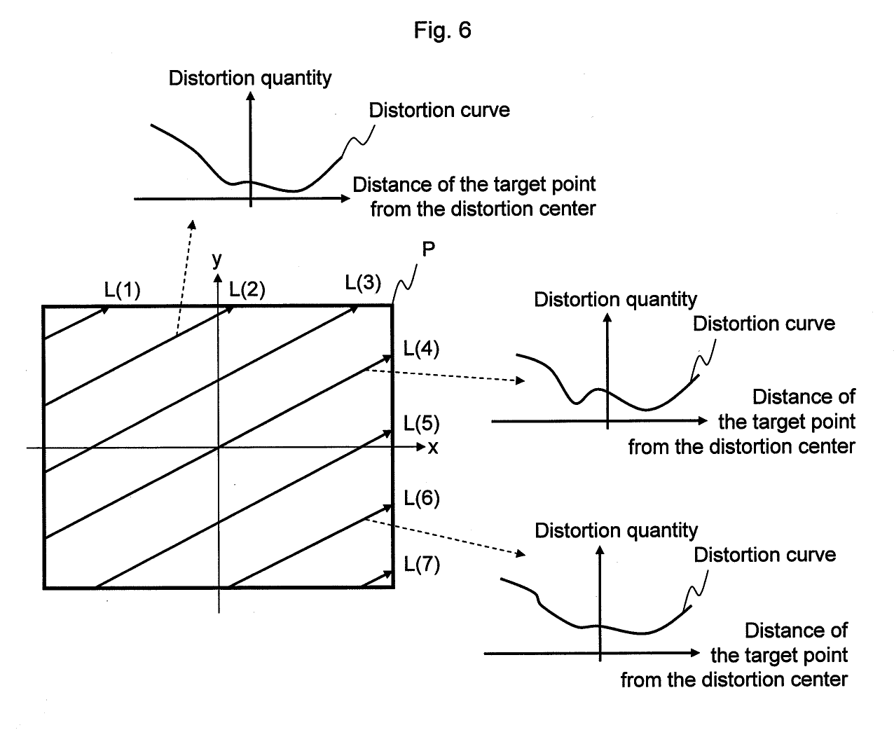

The second type of two-dimensional formula has a plurality of second approximation formulas along a plurality of second lines for specifying distortion quantity (see FIG. 6). The second lines are parallel to each other. FIG. 6 shows the second lines consisting of seven parallel lines.

Each of the second approximation formulas gives a second relationship between the distortion quantity of the target point on each of the second lines and the position of the target point. For example, the position of the target point is given by its distance from the reference point of each of the second lines.

By using the second approximation formulas, the distortion quantity of the target point on or near the second lines is calculated corresponding to the position of the target point.

In these cases, the coefficients of the two-dimensional formula for calculating the distortion quantity are stored in the lens ROM 11, etc., as the data regarding the distortion quantity.

Furthermore, the distortion quantity of a target point that is on one of the first lines is calculated on the basis of one of the first approximation formulas along one of the first lines that passes through the target point.

Similarly, the distortion quantity of a target point that is on one of the second lines is calculated on the basis of one of the second approximation formulas along one of the second lines that passes through the target point.

The distortion quantity of a target point not on one of the first lines is calculated by interpolating one or more of the first approximation formulas along the one or more of the first lines that comes close to the target point.

Similarly, the distortion quantity of a target point not on one of the second lines is calculated by interpolating one or more of the second approximation formulas along the one or more of the second lines that comes close to the target point.

When the two-dimensional formula is used for calculating the distortion quantity, a plurality of two-dimensional approximation formulas is necessary. However, the contents of the formula can be simplified compared to those of the three-dimensional formula. Therefore, the calculation load can be reduced.

Furthermore, instead of the approximation formula for calculating the distortion quantity, the distortion quantities of the plurality of measurement points on the two-dimensional coordinate system for distortion correction may be stored as the information regarding distortion quantity.

In this case, the distortion quantity of a target point collocated with a measurement point is set to the distortion quantity of that measurement point.

The distortion quantity of a target point that is not collocated with a measurement point is calculated by interpolating the distortion quantity (quantities) of one or more measurement point(s). The greater the number of measurement points used in the interpolation calculation the more accurately distortion quantity can be calculated.

If the formula for calculating the distortion quantity is changed (improved), all of the approximation formulas must be changed, meaning that all of the coefficients of the approximation formulas must be changed.

However, even if the formula for calculating the distortion quantity is changed (improved), the values of the distortion quantities of the measurement points stored in the lens ROM, etc., need not be changed.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2007-058606 (filed on Mar. 8, 2007), which is expressly incorporated herein by reference, in its entirety.

1. A photographing device comprising:
a lens; and
a camera body that has an imaging device and an image-processing unit that performs distortion correction on the basis of information regarding distortion quantity, as part of an image processing of an image signal obtained by said imaging device through said lens;
said distortion quantity having at least one of first distortion quantity of said lens and second distortion quantity of said imaging device, said information having a coefficient of an approximation formula for said distortion correction on a two-dimensional coordinate system for said distortion correction, said two-dimensional coordinate system being set on an image obtained by said image processing of said image signal.

2. The photographing device according to claim 1, wherein said approximation formula is a three-dimensional formula that is used for calculating said distortion quantity for a point on said two-dimensional coordinate system.

3. The photographing device according to claim 1, wherein said approximation formula is a two-dimensional formula that has a plurality of first approximation formulas along said plurality of first lines for specifying said distortion quantity, said first lines radiating from a distortion center, said distortion center being the position where said distortion quantity shows the minimum value on said two-dimensional coordinate system for said distortion correction, each of said first approximation formulas giving a first relationship between said distortion quantity of a target point on each of said first lines and the position of said target point.

4. The photographing device according to claim 1, wherein said approximation formula is a two-dimensional formula that has a plurality of second approximation formulas along said plurality of second lines for specifying said distortion quantity, said second lines being parallel to each other, each of said second approximation formulas giving a second relationship between said distortion quantity of a target point on each of said second lines and the position of said target point.

5. The photographing device according to claim 1, wherein said distortion quantity is calculated on the basis of a relational formula, a central deviation value, and a surface-inclination value;
said relational formula is the relational formula between an architectonics-distortion quantity due to the optical characteristics determined by the design of said lens and the distance between a target point and an architectonics-distortion center that is the position where said architectonics-distortion quantity shows the minimum value;
said central deviation value is the deviation between an intersection of an optical axis of said lens with an imaging surface of said imaging device, and the center of said imaging surface; and
said surface-inclination value is the inclination angle of a surface perpendicular to said optical axis of said lens, in the direction of said imaging surface of said imaging device.

6. A photographing device comprising:
a lens; and
a camera body that has an imaging device and an image-processing unit that performs distortion correction on the basis of information regarding distortion quantity, as part of an image processing of an image signal obtained by said imaging device through said lens;
said distortion quantity having at least one of first distortion quantity of said lens and second distortion quantity of said imaging device, said information having said distortion quantities of a plurality of measurement points on a two-dimensional coordinate system for said distortion correction, said two-dimensional coordinate system being set on an image obtained by said image processing of said image signal.
